(19) United States
(12) Patent Application Publication
(10) Pub. No.: US 2011/0284286 A1
(43) Pub. Date: Nov. 24, 2011

(54) DANGLER ASSEMBLY FOR PLATING BARREL

(75) Inventor: Kyung-un Ra, Ansan-si (KR)

(73) Assignee: GWANGSUNG METAL CO., LTD., Gyeonggi-do (KR)

(21) Appl. No.: 13/015,759

(22) Filed: Jan. 28, 2011

(30) Foreign Application Priority Data
May 24, 2010 (KR) 10-2010-0048311

(51) Int. Cl. H02G 15/04

(52) U.S. Cl. 174/75 R

(57) ABSTRACT

A dangler assembly for a plating barrel is provided comprising an electrical cable, a connection terminal, and an electrode terminal, wherein the connection terminal comprises a terminal member including a hollow casing electrically connected to the electrical cable and an end portion electrically connected to the hollow casing, wherein the first end portion of the electrical cable is press-fittingly inserted into the hollow casing, a fastening member that compresses a coupling region between the first end portion of the electrical cable and the hollow casing and fastens the first end portion of the electrical cable to the hollow casing, and a sealing member between the hollow casing and the fastening member to seal a space between the hollow casing and the fastening member.

### CROSS-REFERENCE TO RELATED APPLICATION

This application claims priority to Korean Patent Application No. 2010-48311 filed on May 24, 2010, the contents of which are herein incorporated by reference in its entirety.

### BACKGROUND

1. Technical Field

Embodiments of the present invention relate to a dangler assembly, and more particularly, to a dangler assembly for use in a plating barrel.

2. Discussion of the Related Art

Plating, a surface covering process in which a metal is deposited on a conductive surface of an object, includes electroplating conducted in an electrochemical way, chemical plating, electroless plating, hot dipping plating conducted by melting a metal and submerging an object into the melted metal, scattering plating using a sprayer, and the like, which have been widely used in the plating industry.

For plating of a small-sized metal, the electroplating may be employed because of its high reliability and safety. The electroplating is carried out while an object to be plated is submerged into an electrolyte solution filled in a plating barrel and in a state where the object to be plated becomes a cathode and a metal or an insoluble metal formed of the same material as the object to be plated becomes an anode, if electric current flows to the cathode and anode through a rectifier, the electrolysis for the electrolyte solution is carried out and the metal ions contained in the electrolyte solution are separated and attached to the surface of the object to be plated, such that after a predetermined period of time has been elapsed, the object to be plated forms a thin film thereon and the plating for the object is done.

A plating device using a barrel structure has been suggested to perform the electroplating.

A basic configuration of the plating device using a barrel structure includes a plating tank in which an electrolyte solution is stored and an anode is provided, a barrel adapted to be submerged into the plating tank and having a cathode provided in a body thereof, a fixing frame adapted to fix the barrel thereto, and a motor disposed at the fixing frame for rotating the barrel.

### SUMMARY

Exemplary embodiments of the present invention provide a dangler assembly for a plating barrel that has a sealing member between a terminal member and a fastening member to seal an adjacent portion between an insulation and the terminal member, thereby preventing water or a plating solution from being penetrated into the adjacent portion and also keeping a conductor of an electrical cable and an electrode terminal from being corroded.

According to an embodiment of the present invention, there is provided a dangler assembly for a plating barrel comprising an electrical cable, a connection terminal electrically connected to a first end portion of the electrical cable, and an electrode terminal electrically connected to a second end portion of the electrical cable, such that electrical charges are supplied from an electric current supplier connected to the connection terminal to the electrode terminal contacting a plating solution filled in the plating barrel, wherein the connection terminal comprises a terminal member including a hollow casing electrically connected to the electrical cable and an end portion that is disposed at a side of the hollow casing and electrically connected to the hollow casing, wherein the first end portion of the electrical cable is press-fittingly inserted into the hollow casing, a fastening member that compresses a coupling region between the first end portion of the electrical cable and the hollow casing and fastens the first end portion of the electrical cable to the hollow casing, and a sealing member between the hollow casing and the fastening member to seal a space between the hollow casing and the fastening member.

### BRIEF DESCRIPTION OF THE DRAWINGS

The embodiments of the present invention will be apparent from the following detailed description in conjunction with the accompanying drawings, in which:

FIG. 1 is a sectional view illustrating a barrel plating device having a dangler assembly according to an embodiment the present invention;

FIG. 2 is a sectional view illustrating a connection terminal of a dangler assembly according to a related art;

FIG. 3 is a sectional view illustrating a connection terminal of a dangler assembly according to an embodiment of the present invention;

FIG. 4 is an exploded sectional view illustrating parts of a connection terminal of a dangler assembly according to an embodiment of the present invention;

FIGS. 5A to 5E are sectional views illustrating coupling processes of a dangler assembly according to an embodiment of the present invention;

FIG. 6 is a sectional view illustrating an electrode terminal of a dangler assembly according to an embodiment of the present invention;

FIG. 7 is a photograph showing an electrical cable of a dangler assembly according to an embodiment of the present invention after three-month use in a plating barrel;

FIG. 8 is a photograph showing an electrode terminal of a dangler assembly according to an embodiment of the present invention after three-month use in a plating barrel;

FIG. 9 is a photograph showing an electrical cable and a connection terminal of a dangler assembly according to a related art after three-month use in a plating barrel; and

FIG. 10 is a photograph showing an electrode terminal of a dangler assembly according to a related art after three-month use in a plating barrel.

### DETAILED DESCRIPTION OF THE EMBODIMENTS

Hereinafter, exemplary embodiments of the present invention will be described with reference to the accompanying drawings, wherein the same reference numerals may be used to denote the same or substantially the same elements throughout the specification and the drawings.

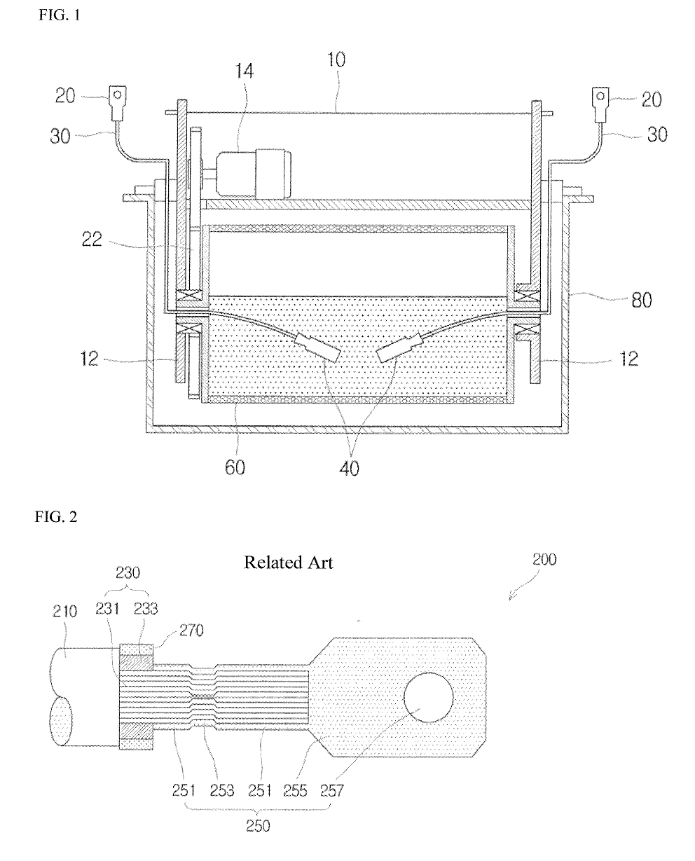

A barrel structure submerged into a plating tank will be described with reference to FIG. 1. FIG. 1 is a sectional view illustrating a general structure of a barrel plating device.

Referring to FIG. 1, the barrel structure basically includes a barrel 60 having fixing plates 12 disposed at both sides thereof, a fixing frame 10 disposed at an upper side thereof and having a motor 14, and a pair of dangler assemblies rotatably shaft-fixed between the fixing plates 12 and the barrel to supply cathode current to an interior of the barrel 60.

The barrel 60 is formed of a synthetic material in a shape of a rounded or polygonal container. Tiny holes are tensely formed on the entire surface of the barrel 60, wherein through the holes, an electrolyte solution freely flows out of the plating tank. Further, the barrel 60 includes a cap detachably mounted at the body thereof. After opening the cap, an object to be plated is received into the body of the barrel 60.

A disc-like gear 22 is formed at one side or both sides of the body of the barrel 60 in such a manner as to be engaged with a gear transmitting a rotary force of the motor 14 disposed at an upper side of the fixing frame 10, thereby allowing the barrel 60 to be rotated in a direction.

Each of the dangler assemblies includes a connection terminal 20 connected to a rectifier (not shown), an insulated electrical cable 30, and an electrode terminal 40 placed in an interior of the barrel 60 to be adjacent to an object to be plated. According to embodiments, the electrical cable 30 may have various shapes, such as a rod, a plate, or the like. The electrical cable 30 is coated with an insulation material. To prevent rotation of the barrel 60 from being inhibited, the electrical cable 30 passes through a hole formed at a side of the barrel 60 into an interior of the barrel 60. The connection terminal 20 and the electrode terminal 40 are formed by rigidly fixing a rod or ball made of a conductive metal (for example, stainless steel) to stripped ends of the electrical cable 30. To prevent rotation of the barrel 60 from being inhibited, the electrical cable 30 is spaced apart from an internal wall surface of the barrel 60 by a predetermined distance. For example, according to an embodiment, the electrical cable 30 may have predetermined stiffness.

According to an embodiment, since the electrode terminal 40 is placed in an electrolyte solution in an interior of the barrel 60, a metal rod or ball is fixedly attached on an end of the electrical cable 30 by welding, soldering, compression or the like to protect the electrical cable placed into the electrolyte solution.

The connection terminal 20 is connected to a cathode of the rectifier disposed at an outside of the barrel 60. A plating process generates heavy moisture and causes water to be scattered to the surface of the connection terminal 20. Accordingly, even though the connection terminal 20 is disposed at an outside of the barrel 60, the electrical cable in the connection terminal 20 needs to be sealed from an outside to prevent water from penetrating into the connection terminal 20.

FIG. 2 illustrates a structure of a connection terminal according to a related art.

Referring to FIG. 2, a connection terminal 200 according to a related art includes a terminal member 250 and a fastening member 270. The terminal member 250 includes a hollow casing 251 electrically connected to an electrical cable 230 and a compressed portion 253 into which an end of the electrical cable 230 is inserted, and an end portion 255 formed at one side of the casing 251 and electrically connected to the casing 251. The fastening member 270 is formed by compressing a coupling region between one end portion of the electrical cable 230 and the casing 251 and by fastening the end portion of the electrical cable 230 to the casing 251.

While the plating process is repeatedly carried out, water or a plating solution remains on the surface of the connection terminal, which may cause various problems. According to the related art, an adjacent portion between an insulation material 233 of the electrical cable 230 and the terminal member 250 is not sealed. A gap may be formed at the adjacent portion, so that water or plating solution may be penetrated into the gap. As a consequence, a conductive cable may be corroded, thus deteriorating conductivity and plating efficiency and shortening life span of the dangler assembly.

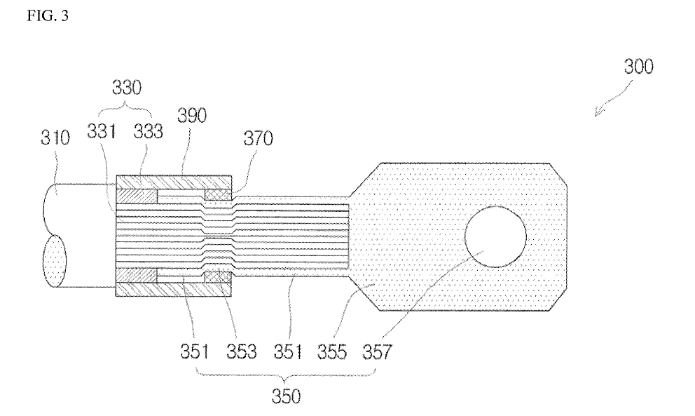

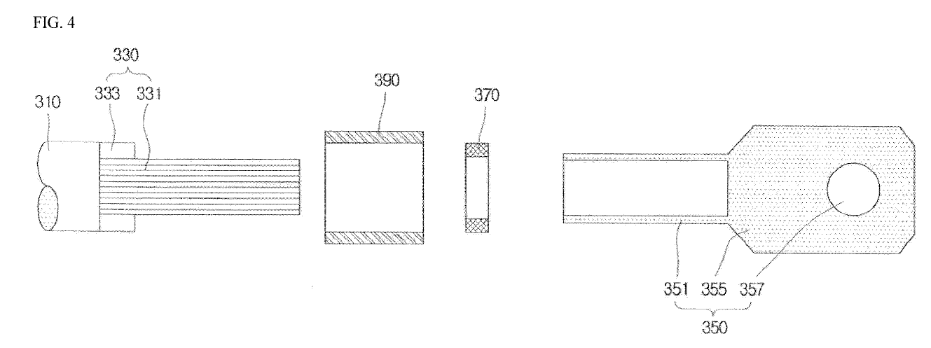

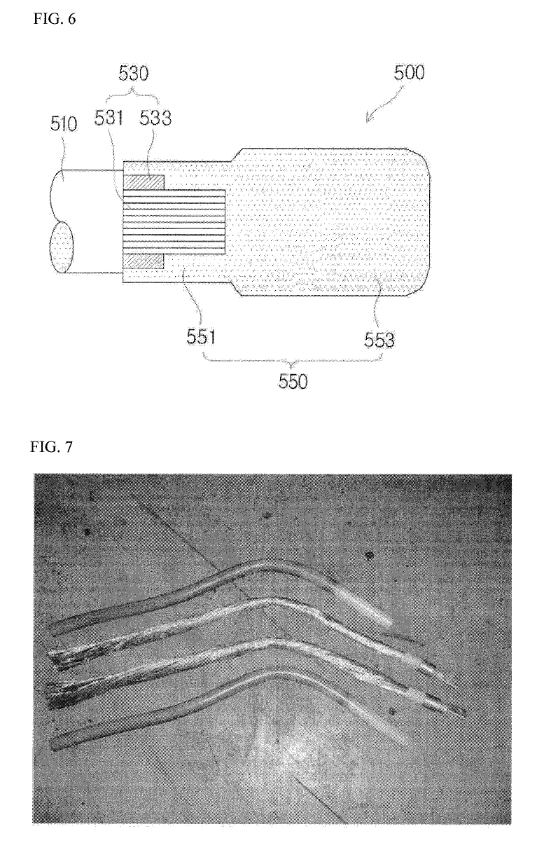

FIG. 3 is a sectional view illustrating a connection terminal of a dangler assembly according to an embodiment of the present invention. FIG. 4 is an exploded sectional view illustrating parts of a connection terminal of a dangler assembly according to an embodiment of the present invention. FIG. 6 is a sectional view illustrating an electrode terminal of a dangler assembly according to an embodiment of the present invention. Referring to FIGS. 1, 3, 4, and 6, a dangler assembly for a plating barrel according to an embodiment of the present invention includes an electrical cable 330, a connection terminal 300 electrically connected to one end portion of the electrical cable 330, and an electrode terminal 500 electrically connected to the other end portion of the electrical cable 330. Negative electric charges are supplied from an electric current supplier (not shown) connected to the connection terminal 300 to the electrode terminal 500 contacting a plating solution filled in a plating barrel 60. The connection terminal 300 includes a terminal member 350, a fastening member 390, and a sealing member 370. The terminal member 350 includes a hollow casing including portions 351 and 353, and an end portion 355. An end portion of the electrical cable 330 is compressed and inserted into the hollow casing that is electrically connected to the electrical cable 330. The end portion 355 is disposed at a side of the hollow casing and electrically connected to the hollow casing. The fastening member 390 compresses a coupling region between one end portion of the electrical cable 330 and the hollow casing and fastens the end portion of the electrical cable 330 to the hollow casing. The sealing member 370 is disposed between the hollow casing and the fastening member 390 to seal a space between the hollow casing and the fastening member 390.

According to an embodiment of the present invention, the hollow casing 351 includes a compressed portion 353 along an outer periphery and compresses the electrical cable 330 inserted into the hollow casing.

According to an embodiment of the present invention, the sealing member 370 is disposed along an outer periphery of the compressed portion 353.

According to an embodiment of the present invention, the sealing member 370 may include an O-ring.

According to an embodiment of the present invention, an end portion of the sealing member 370 and an end portion of the fastening member 390 are placed on the same plane.

According to an embodiment of the present invention, the sealing member 370 is formed of one or more materials selected from the group consisting of synthetic rubber, natural rubber, synthetic resin, and a combination thereof. For example, the sealing member 370 may be formed of one or more material selected from the group consisting of urethane, natural rubber (NR), styrene butadiene rubber (SBR), stereospecific styrene butadiene rubber (stereospecific SBR), polychloroprene rubber (CR), nitrile rubber (NR), cis-chlorobutadiene rubber, ethylene-propylene rubber (EPDM), acrylonitrile butadiene rubber (NBR), butadiene rubber (BR), isoprene rubber (IR), isobutylene isoprene rubber (IIR), soft polyvinyl chloride resin (PVC), low density polyethylene (LDPE), high density polyethylene (HDPE), linear low density polyethylene (LLDPE), polypropylene (PP), polyamide (nylon), mono cast nylon (MC nylon), fluorocarbon resin (Teflon), polytetrafluoroethylene (PTFE), silicone resin, and combinations thereof.

According to an embodiment of the present invention, the terminal member 350 is formed of one or more materials selected from the group consisting of stainless, copper, tin, zinc, brass, iron, aluminum, nickel and alloys thereof.

According to an embodiment of the present invention, the fastening member 390 is formed of one or more materials selected from the group consisting of stainless, copper, tin, zinc, brass, iron, aluminum, nickel and alloys thereof.

Specifically, the electrical cable 330 includes a conductor 331 and an insulation material 333 disposed around the conductor 331. The conductor 331 includes a lengthwise center portion insulated by the insulation material 333 and a lengthwise end portion not insulated by the insulation 333. The electrode terminal 500 is disposed at an end of the electrical cable 330 in a lengthwise direction of the electrical cable 330, and the connection terminal 300 is disposed at the other end of the electrical cable 330 in the lengthwise direction of the electrical cable 330, thereby supplying negative electrical charges from an electric current supplier (not shown) connected to the connection terminal 300 to the electrode terminal 500 contacting a plating solution filled in the plating barrel 60. As described above, the connection terminal 300 includes the terminal member 350, the sealing member 370, and the fastening member 390. The terminal member 350 includes the hollow cylindrical casing including portions 351 and 353. The terminal member 370 may be opened at a side. The hollow cylindrical casing includes the compressed portion 353. The end portion 355 is closed and communicates with the hollow cylindrical casing. The compressed portion 353 is formed by inserting the conductor 331 into the opened hollow cylindrical casing along a lengthwise direction, wherein an end of the insulation material 333 coated around the conductor 331 along the lengthwise direction thereof is placed near a lengthwise end portion of the hollow cylindrical casing. By pressurizing and reducing the hollow cylindrical casing from an outer periphery of the casing toward a center of the casing, an outer periphery of the conductor 331 inserted into the casing abuts an inner periphery of the opened casing 351. The sealing member 370 is formed to have a hollow shape, for example, as an O-ring. An inner periphery of the sealing member 370 is disposed along an outer periphery of the opened casing 351, for example, along an outer periphery of the compressed portion 353. The fastening member 390 is formed to have a hollow cylindrical shape. An inner periphery of an end portion of the fastening member 390 partially abuts an outer periphery of the insulation material 333, and an inner periphery of the other end portion of the fastening member 390 partially abuts an outer periphery of the pressurized casing, for example, an outer periphery of the sealing member 370 disposed along an outer periphery of the compressed portion 353. The fastening member 390 is pressurized and reduced from an outer periphery of the fastening member 390 to a center of the fastening member 390.

According to an embodiment, the electrode terminal 500 disposed at an end portion of the dangler assembly may be made by a compressing way, which is explained with reference to FIG. 6. Referring to FIG. 6, an insulated electrical cable 530 includes an insulation material 533 and an electrical cable 531, wherein the insulation material 533 is disposed around a stripped end portion of an electrical cable 531. A stainless rod 550 is included in the electrode terminal 500. The stainless rod 550 includes an end portion 551 that has a depressed hollow internal structure, wherein a side of the end portion 551 is closed. A portion of the insulated electrical cable 530 and a portion of the electrical cable 531 are inserted into the end portion 551 of the stainless rod 550, and then the end portion 551 of the stainless rod 550 is pressurized and reduced in size, thus completing the electrode terminal 500.

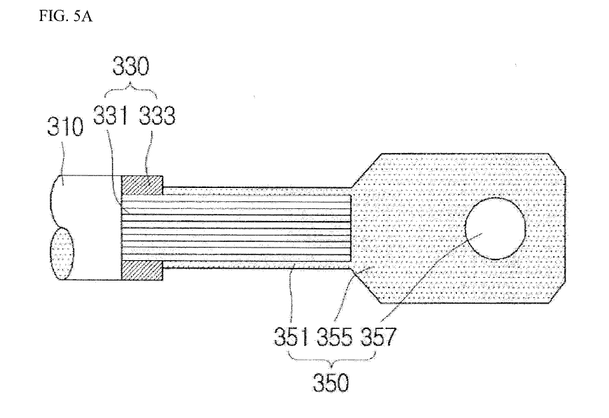

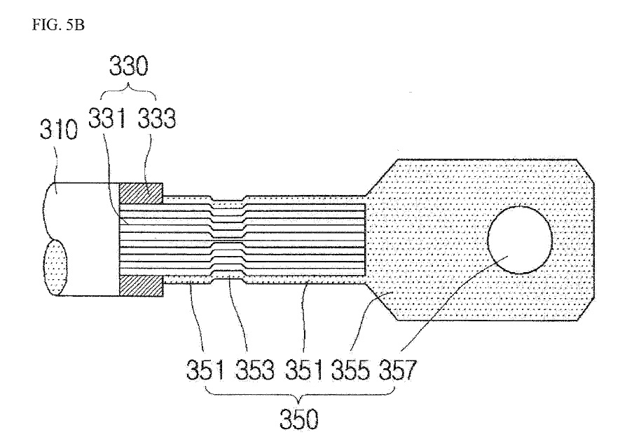

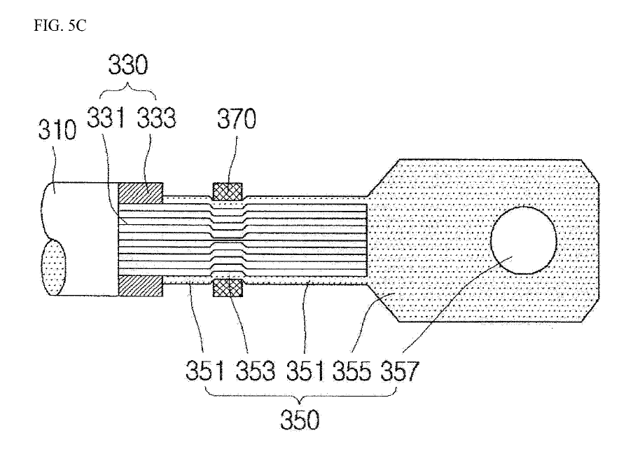

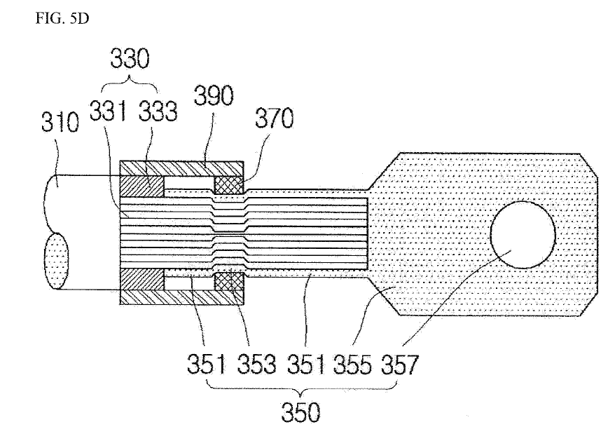

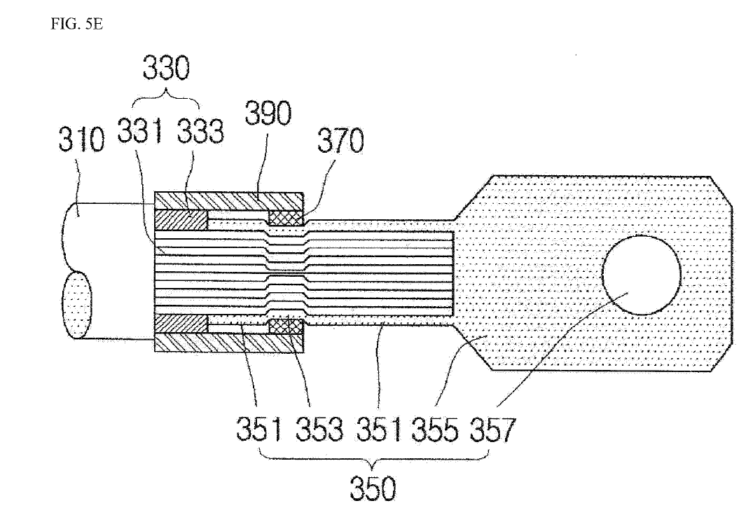

An embodiment of forming the connection terminal 300 at the other end portion of the dangler assembly will now be described in connection with FIG. 5. According to an embodiment, the conductor 331 may be formed of a plurality of copper cables, the insulation material 333 of urethane rubber, the terminal member 350 of stainless steel, the sealing member 370 of urethane rubber, and the fastening member 390 of stainless steel.

Referring to FIG. 5A, the conductor 331 is inserted into the opened casing 351 along a lengthwise direction thereof so that a lengthwise end portion of the insulation material 333 is placed near an end portion of the casing 351. An outer periphery of the conductor 331 abuts an inner periphery of the casing 351.

Then, the opened casing 351 is pressurized from an outer periphery thereof toward a center thereof, so that the compressed portion 353 is formed on the opened casing 351 as shown in FIG. 5B.

Next, the sealing member 370 shaped as a hollow cylinder is disposed so that an inner periphery of the sealing member 370 abuts an outer periphery of the compressed portion 353, as shown in FIG. 5C.

Thereafter, the fastening member 390 shaped as a hollow cylinder is disposed so that an inner periphery of one end portion of the fastening member 390 partially abuts an outer periphery of the insulation material 333 and an inner periphery of the other end portion of the fastening member 390 partially abuts an outer periphery of the sealing member 370, as shown in FIG. 5D.

Finally, the fastening member 390 is pressurized and reduced from an outer periphery of the fastening member 390 toward a center of the fasting member 390, thereby completing the connection terminal 300, as shown in FIG. 5E.

FIG. 7 is a photograph showing an electrical cable of a dangler assembly according to an embodiment of the present invention after three-month use in a plating barrel.

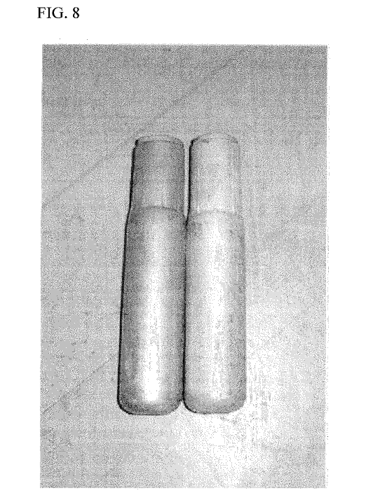

FIG. 8 is a photograph showing an electrode terminal of a dangler assembly according to an embodiment of the present invention after three-month use in a plating barrel.

As a comparative example, a dangler assembly, GALVACONT 150 commercially available from Richard Tscherwitschke GmbH, was used in a plating barrel.

The electrode terminal disposed at an end portion of the dangler assembly, the GALVACONT 150, had the same structure as shown in FIG. 6.

The connection terminal disposed at the other end portion of the dangler assembly, the GALVACONT 150, had the same structure as shown in FIG. 2.

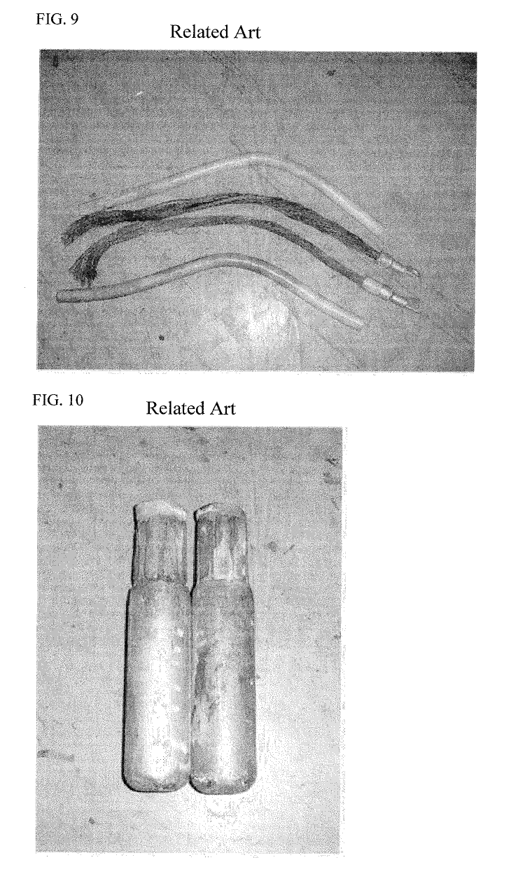

FIG. 9 is a photograph showing an electrical cable of a dangler assembly, GALVACONT 150, according to a related art after three-month use in a plating barrel, and FIG. 10 is a photograph showing an electrode terminal of a dangler assembly, GALVACONT 150, according to a related art after three-month use in a plating barrel.

It was appreciated from FIGS. 7 to 10 that the dangler assembly according to the related art, the GALVACONT 150, showed more serious corrosion states than the dangler assembly according to the embodiments of the present invention when they were used for the same period of time in the same plating barrel.

The dangler assembly according to the embodiments of the present invention exhibited a remarkably low degree of corrosion at the conductor inside the insulation material and the electrode terminal in comparison with the dangler assembly according to the related art.

As consequences, the dangler assembly according to the embodiments of the present invention allow for various advantages, such as increased life span, enhancement in productivity, lowered power consumption, and cost savings.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A dangler assembly for a plating barrel comprising:
an electrical cable;
a connection terminal electrically connected to a first end portion of the electrical cable; and
an electrode terminal electrically connected to a second end portion of the electrical cable, such that electrical charges are supplied from an electric current supplier connected to the connection terminal to the electrode terminal contacting a plating solution filled in the plating barrel,
wherein the connection terminal comprises:
a terminal member including a hollow casing electrically connected to the electrical cable and an end portion that is disposed at a side of the hollow casing and electrically connected to the hollow casing, wherein the first end portion of the electrical cable is press-fittingly inserted into the hollow casing;
a fastening member that compresses a coupling region between the first end portion of the electrical cable and the hollow casing and fastens the first end portion of the electrical cable to the hollow casing; and
a sealing member between the hollow casing and the fastening member to seal a space between the hollow casing and the fastening member.

2. The dangler assembly for a plating barrel according to claim 1, wherein the hollow casing includes a compressed portion formed along an outer periphery such that the electrical cable inserted into the hollow casing is compressed.

3. The dangler assembly for a plating barrel according to claim 2, wherein the sealing member is disposed along an outer periphery of the compressed portion.

4. The dangler assembly for a plating barrel according to claim 1, wherein the sealing member is formed as an O-ring.

5. The dangler assembly for a plating barrel according to claim 2, wherein the sealing member is formed as an O-ring.

6. The dangler assembly for a plating barrel according to claim 2, wherein an end portion of the sealing member and an end portion of the fastening member are placed on the same plane.

7. The dangler assembly for a plating barrel according to claim 3, wherein an end portion of the sealing member and an end portion of the fastening member are placed on the same plane.

8. The dangler assembly for a plating barrel according to claim 1, wherein the sealing member is formed of one or more materials selected from the group consisting of synthetic rubber, natural rubber, synthetic resin, and combinations thereof.

9. The dangler assembly for a plating barrel according to claim 2, wherein the sealing member is formed of one or more materials selected from the group consisting of synthetic rubber, natural rubber, synthetic resin, and combinations thereof.

10. The dangler assembly for a plating barrel according to claim 6, wherein the sealing member is formed of one or more materials selected from the group consisting of urethane, natural rubber (NR), styrene butadiene rubber (SBR), stereospecific styrene butadiene rubber (stereospecific SBR), polychloroprene rubber (CR), nitrile rubber (NR), cis-chlorobutadiene rubber, ethylene-propylene rubber (EPDM), acrylonitrile butadiene rubber (NBR), butadiene rubber (BR), isoprene rubber (IR), isobutylene isoprene rubber (IIR), soft polyvinyl chloride resin (PVC), low density polyethylene (LDPE), high density polyethylene (HDPE), linear low density polyethylene (LLDPE), polypropylene (PP), polyamide (nylon), mono cast nylon (MC nylon), fluorocarbon resin (Teflon), polytetrafluoroethylene (PTFE), silicone resin, and combinations thereof.

11. The dangler assembly for a plating barrel according to claim 1, wherein the terminal member is formed of one or more materials selected from the group consisting of stainless, copper, tin, zinc, brass, iron, aluminum, nickel, and alloys thereof.

12. The dangler assembly for a plating barrel according to claim 2, wherein the terminal member is formed of one or more materials selected from the group consisting of stainless, copper, tin, zinc, brass, iron, aluminum, nickel, and alloys thereof.

13. The dangler assembly for a plating barrel according to claim 1, wherein the fastening member is formed of one or more materials selected from the group consisting of stainless, copper, tin, zinc, brass, iron, aluminum, nickel, and alloys thereof.

14. The dangler assembly for a plating barrel according to claim 2, wherein the fastening member is formed of one or more materials selected from the group consisting of stainless, copper, tin, zinc, brass, iron, aluminum, nickel, and alloys thereof.
